(19) United States
(12) Patent Application Publication
(10) Pub. No.: US 2008/0085816 A1
(43) Pub. Date: Apr. 10, 2008

(54) FITNESS TRAINING HURDLE

(76) Inventors: Bruno Pauletto, Powell, TN (US); James M. Orsulak, Knoxville, TN (US)

Correspondence Address: LUEDEKA, NEELY & GRAHAM, P.C., P O BOX 1871, KNOXVILLE, TN, 37901, US

(21) Appl. No.: 11/869,436

(22) Filed: Oct. 9, 2007

Related U.S. Application Data
(60) Provisional application No. 60/850,543, filed on Oct. 10, 2006.

(51) Int. Cl. A63B 5/16; B28B 1/00

(52) U.S. Cl. 482/15; 264/645

(57) ABSTRACT

An exercise hurdle including a base extending substantially horizontally outwardly from adjacent a periphery of a bottom end of a substantially wedge-shaped upwardly extending tower that angles inwardly from its bottom end to define an elongate crest line. The tower is composed of a soft, resilient polymeric material to prevent injury during use of the exercise hurdle.

### CROSS REFERENCE TO RELATED APPLICATIONS

This application claims priority to provisional patent application No. 60/850,543 filed Oct. 10, 2006 titled FITNESS TRAINING HURDLE.

### FIELD

This invention relates to the field of simple exercise devices. More particularly, this invention relates to an exercise hurdle and a method for manufacturing exercise hurdles.

### BACKGROUND

Exercise hurdles are used by a wide array of athletes for use in plyometric training and other agility, speed, power, and strength exercises. Many individuals who do not compete in athletic events, but wish to maintain optimal physical fitness also use exercise hurdles and similar devices.

Some examples of hurdles currently used by athletes include hurdle cone and pole assemblies and the Smart-Hurdle® system offered by MF Athletic Company of Cranston, R.I.; Gorilla Agility Hurdles offered by Gill Athletics, Inc., of Champaign, Ill.; and Banana Steps hurdles and Graduated Hurdles offered by Goal Sporting Goods, Inc., of Essex, Conn. Many of these hurdles, like the Smart-Hurdle® System or the Graduated Hurdles, require a plurality of parts. Others, like the Banana Steps or the Gorilla Agility Hurdles, have a substantially rigid structure that offers little or no flexibility and resiliency. Such hurdles can resulting in tripping and/or injury and are more easily broken during training.

What is needed, therefore, is an elongate exercise hurdle with a simple soft and resilient unitary structure to prevent injury to a user.

### SUMMARY

The above and other needs are met by an exercise apparatus made of a soft polymeric composition formed into a unitary structure. The soft composition helps to prevent injury to a user while using the exercise apparatus. The resilient properties of the exercise apparatus allow for the desired shape of the exercise apparatus to substantially re-manifest when such shape is altered during use or other encounter.

In one embodiment, the exercise apparatus includes a barrier to aid in physical training that includes an elongate unitary soft polymeric structure including a base and a tower. The base is shaped in a substantially planar fashion and the base extends outwardly from a lower edge of the tower. The base preferably ranges in length from about 300 mm to about 600 mm, and, more preferably, from about 440 mm to about 480 mm. The base preferably ranges in width from about 80 mm to about 200 mm, and, more preferably, from about 110 mm to about 180 mm. The tower includes a substantially hollow structure that arches inwardly from the base to define an elongate crest line such that the height of the exercise apparatus from a bottom surface of the base to the crest line preferably ranges from about 125 mm to about 500 mm. The base is preferably made of polypropylene and the tower is preferably made of a thermoplastic elastomer.

In another embodiment, a method for storing the exercise apparatus is disclosed including the steps of providing a storage apparatus with a vertical extension and placing at least one of the exercise apparatus described above on the storage apparatus such that the vertical extension protrudes through an orifice along the crest line of the exercise apparatus. A related embodiment includes the step of securing the exercise apparatus to the storage apparatus by inserting a securing means through a substantially horizontal orifice along the storage device near an upper end of the extension member.

In another preferred embodiment, a method for manufacturing the exercise apparatus is disclosed including the steps of forming a base by injection molding, attaching the base to a tower mold, and forming the tower using an injection molding process to form a unitary structure.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a perspective view of one embodiment of an exercise apparatus of the present invention;

FIG. 2 depicts a top view of an embodiment of an exercise apparatus;

FIG. 3 depicts a broad side view of an embodiment of an exercise apparatus;

FIG. 4 depicts a narrow side view of an embodiment of an exercise apparatus;

FIG. 5 depicts a bottom view of an embodiment of an exercise apparatus;

FIG. 6 depicts a side view of an embodiment of a storage apparatus for an exercise apparatus; and

FIG. 7 depicts a side view of an embodiment of a storage apparatus including a plurality of exercise apparatus stored thereon.

### DETAILED DESCRIPTION

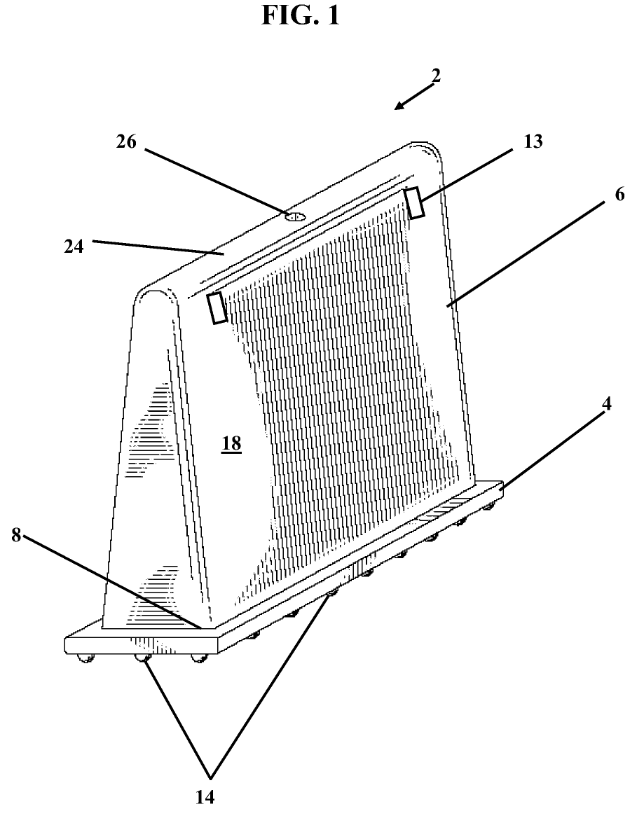

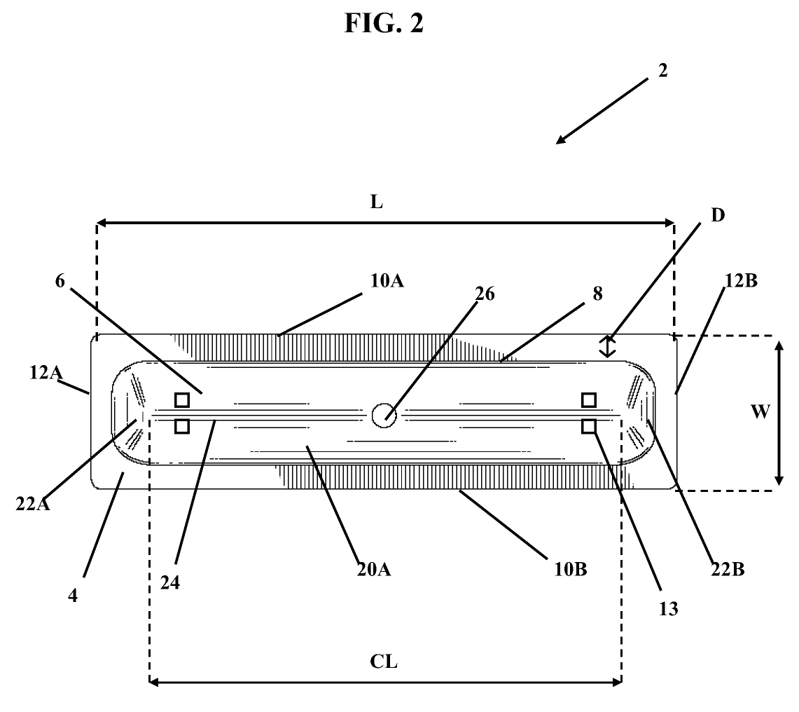

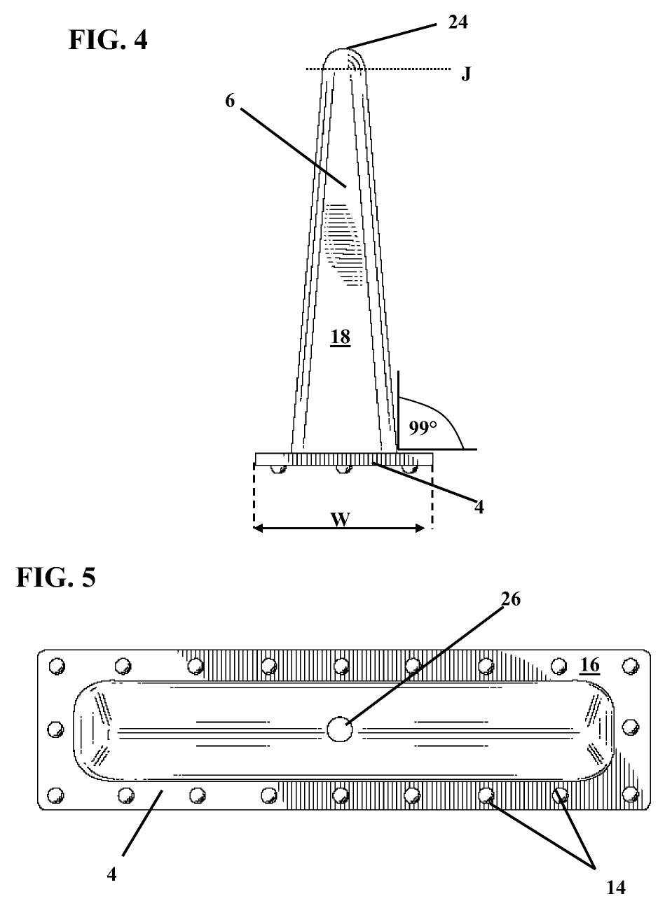

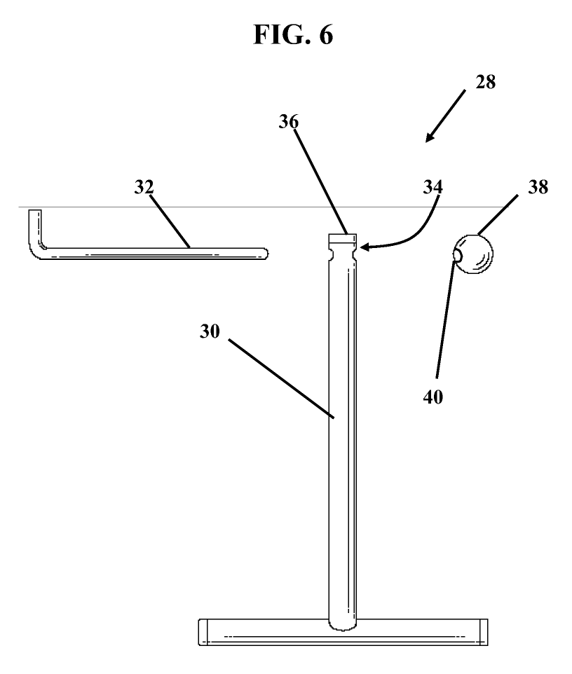

FIG. 1 depicts a perspective view of one embodiment of an exercise apparatus 2 for use as a barrier or hurdle for plyometric or other exercise activities. FIGS. 2-5 show other views of the exercise apparatus 2. Exercise apparatus 2 is shown as a long unitary barrier-like structure including a substantially planar base 4 and a tower 6. Substantially all of exercise apparatus 2 is made from polymeric material. The base 4 is preferably made of polypropylene and the tower 6 is preferably made of a thermoplastic elastomer. In one embodiment, the base 4 preferably has a hardness ranging from about 70 Shore R to about 80 Shore R, and more preferably having a hardness of about 75 Shore R. The tower 6 preferably has a hardness ranging from about 55 Shore A to about 65 Shore A, and more preferably having a hardness of about 60 Shore A. In other embodiments, other suitable polymers with other suitable hardness ranges may be used.

In the embodiment shown in FIGS. 1-5, the base 4 extends outwardly from a lower edge 8 of the tower 6 a distance “D,” ranging from about 15 mm to about 70 mm. The base 4 has a thickness “T” preferably ranging from about 5 mm to about 20 mm. The base length “L,” running along a first elongate side 10A and a second elongate side 10B, preferably ranges from about 300 mm to about 600 mm. The base width “W,” running along a first narrow side 12A and a second narrow side 12B, preferably ranges from about 80 mm to about 200 mm. In other embodiments, the exercise hurdle may have substantially different dimensions suitable for use in exercise activities.

The tower 6 extends upward from the interface between the base 4 and the tower 6 along the first narrow side 12A and the second narrow side 12B at an angle preferably ranging from about 93 degrees to about 97 degrees. Similarly, the angle of the tower 6 at the interface between the base 4 and the tower 6 along the first elongate side 10A and the second elongate side 10B ranges from about 97 degrees to about 101 degrees.

In one embodiment, the tower 6 includes orifices 13 along the elongate sides 10, preferably with two orifices 13 per elongate side as shown in FIGS. 1-3. The orifices 13 provide a place for air to flow through the tower 6. This feature is particularly useful when the exercise apparatus 2 is stepped on because the orifices 13 allow air to more readily escape, allowing the hurdle to collapse quickly. By increasing the rate at which the exercise apparatus 2 collapses when stepped on, many injuries may be avoided. The orifices preferably have a height of about 11 mm and a width of about 8 mm. The orifices are preferably positioned about 55 mm from the edge of the elongate sides 10.

In a preferred embodiment, the base includes a plurality of extension members 14 protruding from a lower surface 16 of the base to provide stability for the exercise apparatus 2. Extension members 14 preferably include rounded or hemispherical shaped members molded into the lower surface 16 of the base 4. However, extension members such as extension members 14 may come in various shapes and relative sizes. Further, extension members 14 may not be included in some embodiments of the exercise apparatus.

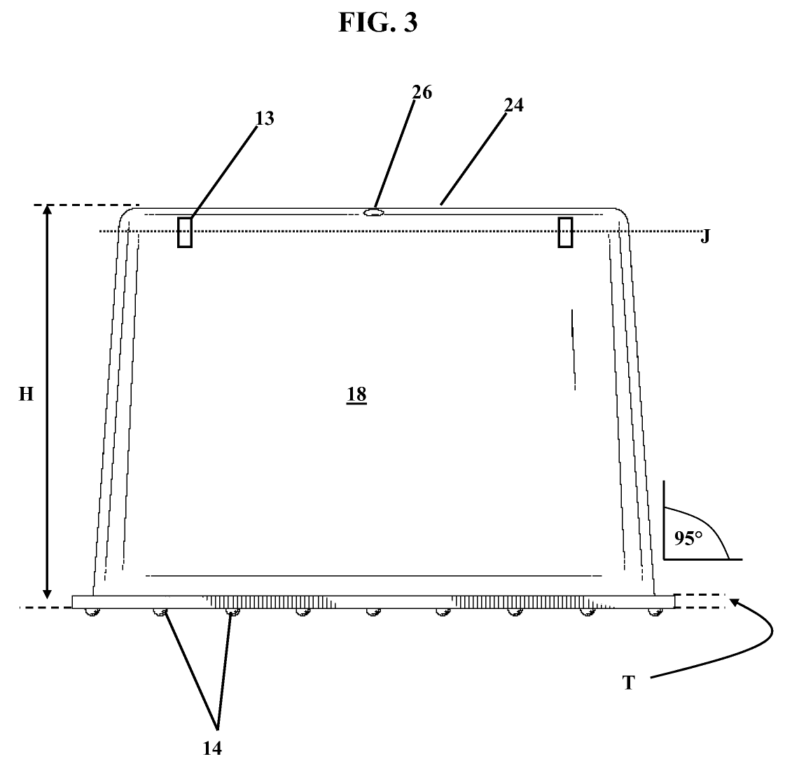

As shown in FIGS. 3-5, the tower 6 is substantially hollow and has an angled outer surface 18 including first broad surface 20A, second broad surface 20B, first slender surface 22A, and second slender surface 22B. Exercise apparatus 2 has a height “H” measured between a lower surface 16 of the base 4 and a crest line 24 on the tower 6 defined by the merging of all of the side surfaces (20A, 20B, 22A, and 22B) at substantially the same elevation from the base 4. Height H preferably ranges from about 125 mm to about 500 mm.

Side surfaces 20A, 20B, 22A, and 22B preferably begin to curve and merge together at “J” located from about 10 to about 16 mm below the crest line 24. At “J,” the width of tower 4 preferably ranges from about 16 mm to about 22 mm. The crest line 24 has a crest line length “CL” ranging from about 300 mm to about 500 mm, and, more preferably, from about 325 mm to about 425 mm. In the illustrated embodiment, the tower 6 includes an orifice 26 located at approximately the midpoint of the crest line 24 for storage as discussed in more detail herein.

An embodiment of the invention also includes a method for storing an exercise apparatus 2. The method includes the step of providing a storage apparatus 28 including a vertical extension member 30 as shown in FIG. 6. The method includes the additional step of placing at least one of the exercise apparatus 2 on the storage apparatus 28 by situating orifice 26 of the exercise apparatus about the vertical extension member 30 of the storage apparatus 28 such that the vertical extension member 30 protrudes through the orifice 26 in the crest line 24 of the exercise apparatus 2.

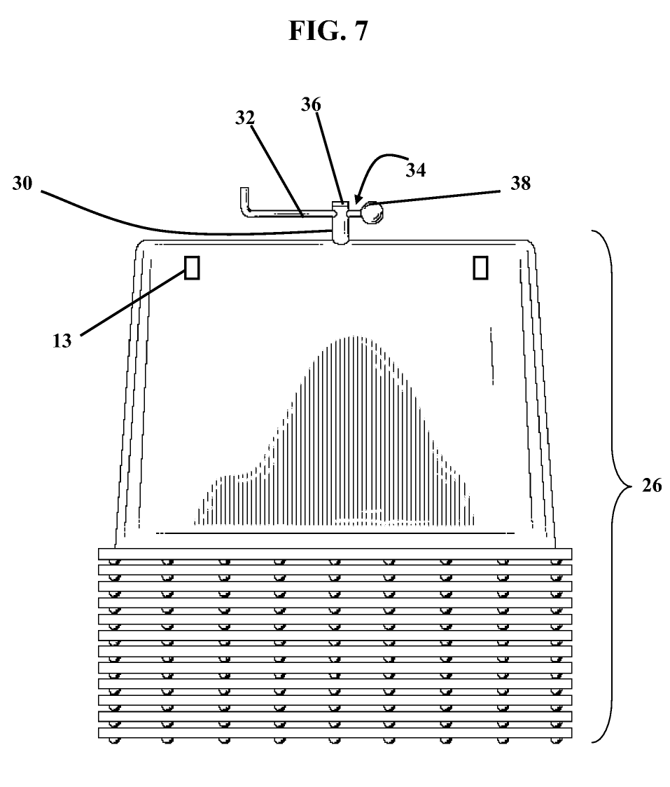

In a related embodiment, the method described above further includes securing at least one exercise apparatus 2 to storage apparatus 28 using a securing mechanism. The securing mechanism preferably includes a rod 32 for extending through a rod orifice 34 located near a first end 36 of the vertical extension member 30. Rod 32 is preferably made of steel and oriented in an L-shape. However, other robust materials such as metals or hard plastics may be used. Rod 32 is then attached to an end piece 38 to prevent the rod 32 from easily slipping back out of the rod orifice 34. In a preferred embodiment, rod 32 is threaded at one end in order to easily and securely screw into a female threaded port 40 of end piece 38. However, those skilled in the art appreciate that a variety of different mechanisms for rod 32 to be attached to end piece 38 are available. Additionally, rod 32 may come in a variety of shapes so long as rod 32 is capable of being extended through rod orifice 34 for attachment to an end piece such as end piece 38. FIG. 7 shows a plurality of exercise apparatus 2 stored along vertical extension member 30 of storage apparatus 28 including a securing mechanism similar to the ones described above.

The exercise apparatus 2 described above in various embodiments may be manufactured by a method including the steps of forming the base 4, attaching the base 4 to a tower mold, and forming the tower 6. The base 4 is preferably formed from a polypropylene material during a base molding step using injection molding techniques known to those skilled in the art. After the base 4 is attached to a tower mold, a similar or identical molding technique is preferably used to form the tower 6 from a thermoplastic elastomer material during a tower molding step. The tower 6 is preferably molded to the base 4 during the tower molding step.

The base molding step is preferably carried to substantial completion at about 55 seconds to about 65 seconds. The tower molding step is preferably carried to substantial completion at about 115 to about 155 seconds. In a particular embodiment wherein the height H ranges from about 148 mm to about 157 mm, the tower molding step is preferably carried to substantial completion in about 120 seconds. In a particular embodiment wherein the height H ranges from about 300 mm to about 310 mm, the tower molding step is preferably carried to substantial completion in about 150 seconds. During the tower molding step, the base 4 is preferably kept at a temperature ranging from about 150 degrees Centigrade to about 200 degrees Centigrade. During the tower molding step, the tower 6 is preferably kept at a temperature ranging from about 130 degrees Centigrade to about 190 degrees Centigrade.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical applications, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An exercise hurdle for use as a barrier to aid in physical training, the hurdle comprising an elongate unitary structure including a base extending substantially horizontally outwardly from adjacent a periphery of a bottom end of a substantially wedge-shaped upwardly extending tower that angles inwardly from its bottom end to define an elongate crest line, the tower comprising a flexible, resilient polymeric material to prevent injury during use of the exercise apparatus.

2. The exercise hurdle of claim 1, wherein the tower further comprises an orifice extending through the crest line for use in storing the exercise hurdle on a storage apparatus.

3. The exercise hurdle of claim 1, wherein the base further comprises a plurality of extension members extending from a bottom side of the base substantially downwardly away from the tower.

4. The exercise hurdle of claim 1, wherein the tower is substantially hollow with an opening adjacent its bottom end.

5. The exercise hurdle of claim 1, wherein the base is substantially planar and has a substantially rectangular outside perimeter.

6. The exercise hurdle of claim 1 wherein the base length ranges from about 300 mm to about 600 mm, the base width ranges from about 80 mm to about 200 mm, and the exercise hurdle height ranges from about 140 mm to about 320 mm.

7. The exercise hurdle of claim 1 wherein the base comprises a polymeric material having a hardness ranging from about 70 Shore R to about 80 Shore R.

8. The exercise hurdle of claim 1 wherein the tower comprises a polymeric material having a hardness ranging from about 55 Shore A to about 65 Shore A.

9. The exercise hurdle of claim 1 wherein the tower comprises one or more thermoplastic elastomer materials.

10. The exercise hurdle of claim 1 wherein the base comprises a polypropylene material.

11. A method of storing the exercise hurdle of claim 2 comprising the steps of providing a storage apparatus including a vertical extension member and disposing at least one exercise hurdle of claim 2 on the storage apparatus such that the vertical extension member protrudes through the orifice along the crest line of at least one of the exercise hurdle.

12. The method of claim 11 further comprising the step of securing the at least one exercise hurdle to the storage apparatus by inserting a securing mechanism through a substantially horizontal orifice adjacent an upper end of the extension member.

13. A method for manufacturing the exercise hurdle of claim 1 comprising the steps of:
a. forming the base from a first polymeric material using an injection molding process;
b. attaching the base to a tower mold; and
c. forming the tower from a second polymeric material using an injection molding process such that the tower is integral with the base and the second polymeric material is more flexible than the first polymeric material.

14. An exercise apparatus for use in physical training, the apparatus comprising an elongate unitary structure including a base extending substantially horizontally outwardly adjacent a lower periphery of a tower which extends substantially upwardly from the interface of the base and the tower to a crest, wherein the tower comprises a soft, resilient thermoplastic elastomer material to prevent injury during exercise activities.

15. The exercise apparatus of claim 1, wherein the tower thermoplastic elastomer material has a hardness ranging from about 55 Shore A to about 65 Shore A.

16. The exercise apparatus of claim 14 wherein the tower further comprises an orifice extending through the tower on the crest line for storing the exercise apparatus on a storage apparatus.

17. The exercise apparatus of claim 14 wherein the base further comprises a plurality of extension members extending from a bottom side of the base substantially downwardly away from the tower.

18. The exercise apparatus of claim 14 wherein the base further comprises a substantially rectangular perimeter with a length ranging from about 440 mm to about 480 mm along the two elongate sides, and a width ranging from about 110 mm to about 180 mm along the two narrow sides.

19. The exercise apparatus of claim 14 wherein the tower comprises a substantially hollow wedge-shaped structure that angles inwardly from a substantially rectangular opening in the base to an elongate crest line adjacent narrow sides of the base at an angle ranging from about 93 degrees to about 97 degrees and adjacent the elongate sides of the base at an angle ranging from about 95 degrees to about 101 degrees, and further wherein the exercise apparatus height from a bottom surface of the base to the crest line ranges from about 140 mm to about 320 mm.

20. The exercise apparatus of claim 14 wherein the base comprises a polypropylene material.

21. A method for manufacturing an exercise hurdle wherein the exercise hurdle includes an elongate polymeric structure including a base and a tower, the method comprising the steps of:
a. forming the base by an injection molding process wherein a first polymeric material is injected into a base mold;
b. attaching the base to a tower mold; and
c. forming the tower by an injection molding process wherein a second polymeric material is injected into the tower mold such that the tower is
d. molded to the base during the tower molding step to form a unitary structure.

22. The method of claim 21, wherein the first polymeric material comprises a polypropylene material and the second polymeric material comprises a thermoplastic elastomer.

23. The method of claim 21, wherein the first polymeric material is substantially continuously kept at a temperature ranging from about 150 to about 200 degrees Celsius while the first polymeric material is located in the base mold.

24. The method of claim 21, wherein the second polymeric material is substantially continuously kept at a temperature of about 130 to about 190 degrees Celsius while the second polymeric material is located in the tower mold.
